(19) United States
(12) Patent Application Publication
(10) Pub. No.: US 2007/0124993 A1
(43) Pub. Date: Jun. 7, 2007

(54) Method and system for retractable portable shield

(76) Inventors: Kevin Johnson, Miramar, FL (US); Yasmine Johnson, Miramar, FL (US)

Correspondence Address: AKERMAN SENTERFITT, P.O. BOX 3188, WEST PALM BEACH, FL, 33402-3188, US

(21) Appl. No.: 11/292,815

(22) Filed: Dec. 2, 2005

(51) Int. Cl. A01G 13/02; A01G 1/08

(52) U.S. Cl. 47/29.5; 47/33

(57) ABSTRACT

A retractable protective shield (20) includes a first stake member (22), a second stake member (24) and a sheet member (26) having a first end attached to the first stake member and a second end attached to the second stake member. The shield can further include a cylinder (30) enclosing a substantial portion of at least the first stake member. The sheet member can retract within the cylinder using a crank member (28) or can be self-retracting within the cylinder. For smooth extraction or retraction operation of the sheet member, the shield can include a bearing (32 or 33). The bearing can include a lock mechanism or the lock mechanism can be implemented similar to lock mechanisms used in window shades. Optionally, the 20 can include pocket or sleeve portions (34) within the sheet member to enable insertion of rigid insert members (36) that can optionally serve as additional stakes.

### FIELD

This invention relates generally to protective shields, and more particularly to protective shield used for protection of predetermined areas.

### BACKGROUND

Homeowners and contractors routinely apply fertilizers and other chemicals containing iron to their lawns and gardens. This iron causes stains on pavements or concrete surfaces requiring time consuming cleaning efforts. Fertilizers and other chemicals may also spill over onto flower beds and other landscaped areas causing unintentional damage. Some homeowners and landscapers use fixed edging or coping to avoid such unintentional damage, but such fixed edging is typically either ineffective in preventing such damage or unsightly for the purpose of providing decorative edging.

### SUMMARY

In a first embodiment of the present invention, a retractable protective shield can include a first stake member and at least a second stake member and a sheet member having a first end attached to the first stake member and a second end attached to the second stake member. The shield can further include a retractable mechanism at either the first end or the second end of the sheet member. The sheet member can be made out of plastic or other suitable material such as vinyl tarp material and the stakes can be made of rigid materials such as hard plastics or metal. The shield can further include a cylinder enclosing a substantial portion of at least the first stake member or the second stake member. The sheet member can retracts within the cylinder using a crank member or can be self-retracting within the cylinder. The shield can also include a lock mechanism for selectively locking a length portion of the sheet member during extraction or retraction. For smooth extraction or retraction operation of the sheet member, the shield can also include a bearing. Optionally, the shield can include pocket or sleeve portions within the sheet member to enable insertion of rigid insert members that can optionally serve as additional stakes. The first or second stake members can be selectively attached to the sheet member using a clamp mechanism for example on the first or second stake members. Note, the sheet member can be attached to an upper portion of the first stake member and second stake member exposing at least a 6 inch portion of a bottom portion of the first stake member and the second stake member. In another aspect a top portion of the first stake portion can rotate relative to a bottom portion of the first stake portion.

In a second embodiment of the present invention, a retractable landscaping protective shield can include a first rigid stake member, a vinyl tarp having a first end attached to the first stake member, a second rigid stake member attached to a second end of the vinyl tarp, and a retractable mechanism at the first end or second end of the vinyl tarp. The shield can further include a cylinder enclosing a substantial portion of at least the first rigid stake member or the second rigid stake member. The shield can also optionally include one or more sleeves within the vinyl tarp and between the first end and the second end to enable the insertion of one or more rigid insert members. As previously noted, the first stake member or second stake member can be selectively attached to the sheet member using a clamp mechanism.

In a third embodiment of the present invention, a method of forming a portable landscaping barrier can include the steps of staking a first stake member into a ground surface, extracting a sheet member of a desired length from the first stake member, wherein the sheet member is attached to the first stake member, and staking a second stake member attached to the sheet member into the ground surface to provide the portable landscaping barrier. The method can further include the steps of unstaking the second stake member from the ground surface and retracting the sheet member towards the first stake member.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “suppressing” can be defined as reducing or removing, either partially or completely.

### BRIEF DESCRIPTION OF THE DRAWINGS

FIG. 1 is an illustration of a retractable protective shield in accordance with an embodiment of the present invention.

FIG. 2 is an illustration of another retractable protective shield in accordance with an embodiment of the present invention.

FIG. 3 is an illustration of a garden setting where the retractable protective shield of FIG. 1 can be used in accordance with an embodiment of the present invention.

FIG. 4 is a flow chart illustrating a method of forming a portable landscaping barrier in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

Embodiments herein provide a product and method that creates a barrier or shield to fertilizers and other chemicals from pavements, concrete surfaces and other designated areas such as landscaped areas. Such barrier can prevent inadvertent landscape damage and avoid strenuous chemical cleanup after application of such fertilizers and chemicals. The barrier or shield can also provide even and straight lines of demarcation upon application of such chemicals and fertilizers.

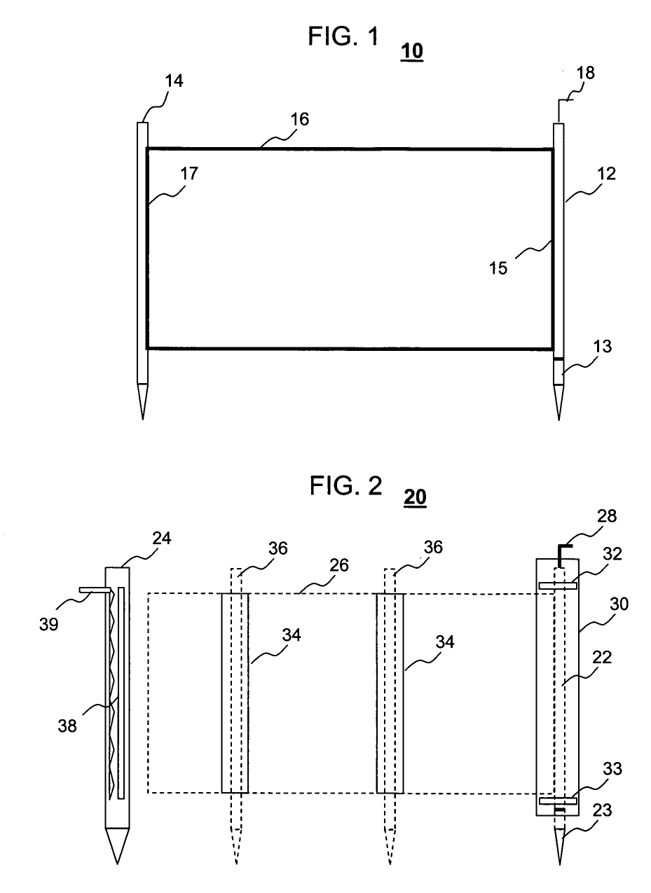

Referring to FIG. 1, a retractable protective shield 10 is shown including a first stake member 12 and at least a second stake member 14 and a sheet member 16 having a first end 15 attached to the first stake member 12 and a second end 17 attached to the second stake member 14. The shield 10 can further include a retractable mechanism at either the first end 15 or the second end 17 of the sheet member 16. The retractable mechanism can use a hand crank 18 or can be self-retracting similar to the mechanisms used for window shades or window treatments enabling the rolling up and down of window shades and can be contained within a cylinder (30) as illustrated in FIG. 2. The retractable mechanism can be spring loaded (not shown). The sheet member 16 can be made out of plastic or other suitable material such as vinyl tarp material that adequately serves as a barrier to chemicals, fertilizers, and liquids without any or significant degradation of the sheet member. The stakes 12 and 14 can be made of rigid materials such as hard plastics or metal. Some recycled plastics, polyvinylchloride (PVC), as well as steel, aluminum or any number of alloys can be used. Note, the first stake portion 12 can optionally include a top portion that rotates relative to a bottom portion 13 of the first stake member 12. Thus, while the bottom portion 13 is staked and fixed into the ground, the top portion of the stake member 12 can still rotate and wind-up the sheet member 16 upon itself using the stake member 12 as a guide.

Referring to FIG. 2, another retractable protective shield 20 can include a first stake member 22 and at least a second stake member 24 and a sheet member 26 having a first end attached to the first stake member 22 and a second end attached to the second stake member 24. The shield 20 can further include a cylinder 30 enclosing a substantial portion of at least the first stake member 22. The cylinder 30 can alternatively or optionally enclose the second stake member. The sheet member 26 can retract within the cylinder 30 using a crank member 28 or can be self-retracting within the cylinder. The shield can also include a lock mechanism for selectively locking a length portion of the sheet member during extraction or retraction. For smooth extraction or retraction operation of the sheet member 26, the shield 20 can also include a bearing 32 and/or 33. The bearing (32 or 33) can include the lock mechanism or the lock mechanism can be implemented similar to lock mechanism used in window shades. Optionally, the shield 20 can include pocket or sleeve portions 34 within the sheet member 26 to enable insertion of rigid insert members 36 that can optionally serve as additional stakes. Note, the rigid insert members 36 do not necessary need to be stakes and can primarily be used to provide stiffness or rigidity to the sheet member while it is in an extracted position. The inserts can help prevent the sheet member 26 from folding over in middle sections, particularly when the sheet member 26 is extended out for a long length. The first or second stake members 22 or 24 can be selectively attached to the sheet member 26 using a clamp mechanism 38 for example on the second stake member 24. A handle 39 on the clamp mechanism 38 can be used to enable the attachment or detachment of the sheet member 26 from the stake member. Note, the sheet member 26 can be attached to an upper portion of the first stake member and second stake member exposing at least a 6 inch portion of a bottom portion of the first stake member and the second stake member. In another aspect a top portion of the first stake portion 22 can rotate relative to a bottom portion 23 of the first stake portion 22.

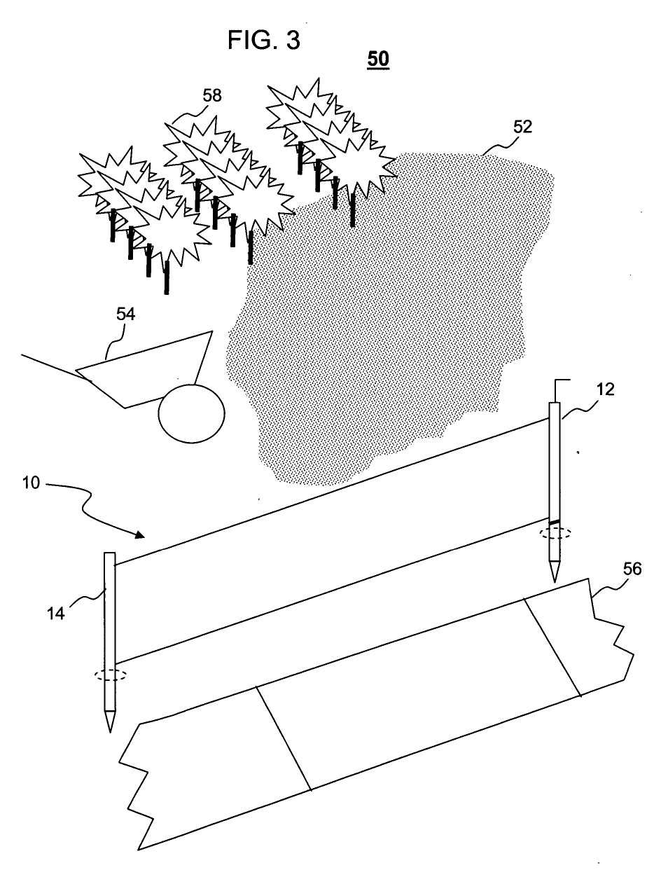

Referring to FIG. 3, the landscape shield or barrier 10 is illustrated in a typical use case environment 50 such as a garden setting. The environment 50 can include a garden having a bed of flowers 58 adjacent to a sidewalk 56. A home gardener or a commercial gardener or landscaper may use a spreader 54 to disperse fertilizer or weed killer or other chemicals 52 on the flower bed 58 or surrounding yard. As discussed above, such fertilizers or chemicals 52 typically contain iron or other elements that cause stains on pavements and sidewalks that are sometimes difficult to remove. Use of the shield or barrier 10 staked (using stakes 12 and 14) between the sidewalk 56 and the area where fertilizer 52 is desired can prevent the spread of fertilizer upon the sidewalk 56. The barrier 10 can be moved around and set up easily be extracting and retracting the sheet member or tarp as needed.

In one particular embodiment or implementation, the product can be comprised of a thirty inch wide or tall sheet of plastic tarp attached on one or both ends to plastic cylinder bases with a retractable mechanism as previously discussed. The plastic sheet can have a maximum extension, for example, of twenty-five feet. The cylinder bases can be anchored in place by thick plastic stakes attached on the bottom of the cylinders. The plastic sheet can be further anchored by thick plastic stakes in individual sleeves positioned in three feet intervals although other intervals or no intervals are certainly contemplated.

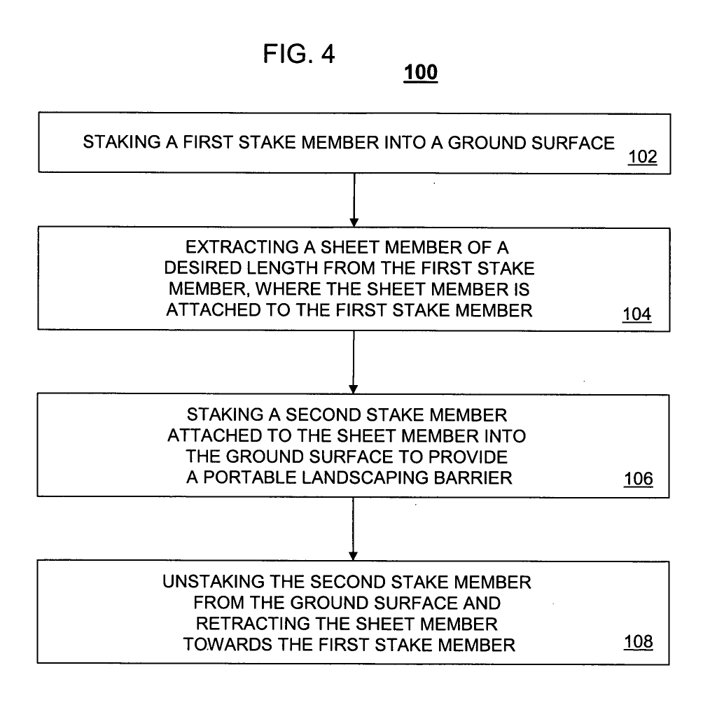

Referring to FIG. 4, a method 100 of forming a portable landscaping barrier can include the step 102 of staking a first stake member into a ground surface, extracting a sheet member of a desired length from the first stake member at step 104, and staking a second stake member attached to the sheet member into the ground surface to provide the portable landscaping barrier at step 106. The method 100 can further include the step 108 of unstaking the second stake from the ground surface and retracting the sheet member towards the first stake member. Note, the steps of the method described above can be implemented in any order and do not need to follow the order outlined in FIG. 4. For example, the sheet member can be extracted and staking of the second stake can occur first or simultaneously with the staking of the first stake.

In light of the foregoing description, it should also be recognized that embodiments in accordance with the present invention can be realized in numerous configurations contemplated to be within the scope of the claims. Additionally, the description above is intended by way of example only and is not intended to limit the present invention in any way, except as set forth in the following claims.

What is claimed is:

1. A retractable protective shield, comprising:
a first stake member and at least a second stake member; and
a sheet member having a first end attached to the first stake member and a second end attached to the second stake member.

2. The retractable protective shield of claim 1, wherein the shield further comprises a retractable mechanism at one among the first end or second end of the sheet member.

3. The retractable protective shield of claim 1, wherein the sheet member comprises a vinyl tarp material.

4. The retractable protective shield of claim 1, wherein the shield further comprises a cylinder enclosing a substantial portion of at least the first stake member or the second stake member.

5. The retractable protective shield of claim 1, wherein the shield further comprises one or more rigid insert members for insertion within pocket or sleeve portions of the sheet member.

6. The retractable protective shield of claim 1, wherein the first stake member or second stake member is selectively attached to the sheet member.

7. The retractable protective shield of claim 4, wherein the sheet member retracts within the cylinder using a crank member.

8. The retractable protective shield of claim 4, wherein the sheet member is self-retracting within the cylinder.

9. The retractable protective shield of claim 4, wherein the shield further comprises a lock mechanism for selectively locking a length portion of the sheet member during extraction or retraction.

10. The retractable protective shield of claim 4, wherein the shield further comprises a bearing enabling the smooth extraction or retraction of the sheet member.

11. The retractable protective shield of claim 1, wherein the sheet member is attached to an upper portion of the first stake member and second stake member exposing at least a 6 inch portion of a bottom portion of the first stake member and the second stake member.

12. The retractable protective shield of claim 1, wherein a top portion of the first stake portion rotates relative to a bottom portion of the first stake portion.

13. The retractable protective shield of claim 6, wherein the first stake member or second stake member is selectively attached to the sheet member using a clamp mechanism on the first stake member or the second stake member.

14. The retractable protective shield of claim 1, wherein the first stake member and the second stake member are comprised of rigid plastic or metal.

15. A retractable landscaping protective shield, comprising:
a first rigid stake member;
a vinyl tarp having a first end attached to the first stake member;
a second rigid stake member attached to a second end of the vinyl tarp; and
a retractable mechanism at the first end or second end of the vinyl tarp.

16. The retractable landscaping shield of claim 15, wherein the shield further comprises a cylinder enclosing a substantial portion of at least the first rigid stake member or the second rigid stake member.

17. The retractable protective shield of claim 15, wherein the shield further comprises one or more sleeves within the vinyl tarp and between the first end and the second end to enable the insertion of one or more rigid insert members.

18. The retractable protective shield of claim 1, wherein the first stake member or second stake member is selectively attached to the sheet member using a clamp mechanism.

19. A method of forming a portable landscaping barrier, comprising the steps of:
staking a first stake member into a ground surface;
extracting a sheet member of a desired length from the first stake member, wherein the sheet member is attached to the first stake member;
staking a second stake member attached to the sheet member into the ground surface to provide the portable landscaping barrier.

20. The method of claim 19, wherein the method further comprises the steps of unstaking the second stake member from the ground surface and retracting the sheet member towards the first stake member.
